(19) United States
(12) Patent Application Publication
(10) Pub. No.: US 2026/0008309 A1
(43) Pub. Date: Jan. 8, 2026

(54) Amphibious Robot

(71) Applicant: Xi'an Jiaotong University, Xi'an (CN)

(72) Inventors: Qiji Ze, Xi'an (CN); Xingyu Shi, Xi'an (CN); Guangqian Zhao, Xi'an (CN); Xingguo Li, Xi'an (CN); Deliang Liang, Xi'an (CN)

(73) Assignee: Xi'an Jiaotong University, Xi'an, SN (CN)

(21) Appl. No.: 19/325,399

(22) Filed: Sep. 10, 2025

(30) Foreign Application Priority Data
May 30, 2025 (CN) 202510719476.9

(51) Int. Cl. B60F 3/00; B63G 8/00; B63G 8/04; B63G 8/08; B63G 8/14

(52) U.S. Cl. CPC B60F 3/0007; B60F 3/0061; B63G 8/001; B63G 8/04; B63G 8/08; B63G 8/14; B63G 2008/002

(57) ABSTRACT

The present invention relates to the technical field of amphibious robots, and discloses an amphibious robot, comprising: a fuselage and a driving mechanism, with a steering mechanism and a pitching mechanism respectively connected thereto, wherein the fuselage comprises an inner shell, a propeller and a rolling outer shell which are sequentially sleeved from the inside to the outside. One side end of the inner shell is connected to a rotor of a driving motor, and the other side end is rotatably connected to the bracket and a counterweight. Rotation of the drive motor provides a power torque to the fuselage, and causing the inner shell, the propeller and the rolling outer shell to rotate synchronously. Thus the robot is driven to move on the water surface/water by the reaction force. The amphibious robot provided by the present invention simplifies the driving system and its control system.

### TECHNICAL FIELD

The present invention relates to the technical field of amphibious robots, and in particular to an amphibious robot.

### BACKGROUND

Amphibious robots have the ability to move on land and water, and can perform a variety of tasks in complex environments at the junction of land and water, including monitoring, exploration, pollution detection, search and rescue, etc. Accordingly, amphibious robotics is active area of research. However, the complexity of amphibious operating environments carries with it huge difficulties in the design and development of amphibious robots, with correspondingly high demands on the robot's operating principles, structural design, power systems, etc.

At present, there are two approaches to the design of amphibious robot drive systems: 1. The robot has multiple drive systems. When the robot changes in the operating environment, it can adapt to the new environment by switching the drive system; 2. The robot is equipped with only one integrated drive system, which enables the robot to move in both land and water environments.

Amphibious robots equipped with multiple independent drive systems usually have complex structures and controls, which creates difficulties for the miniaturization of robots. For example, foot-propeller hybrid and foot-water jet amphibious robots use robotic legs or feet to operate on land, and use independent propellers or water jet systems to achieve propulsion in water. Some amphibious robots combine variants of multiple independent drive systems, such as amphibious robots using foot-paddle, foot-fin, wheel-paddle-fin and other drive systems. This two-purpose drive system structure does not completely overcome the shortcomings of multiple drive systems, and the drive control system is still relatively complex. In contrast, another class of amphibious robot does not switch structures or drive systems in water and land environments. Such systems include tracked, spherical and bionic amphibious robots. Among these, tracked amphibious robots have good obstacle crossing performance and strong carrying capacity, but they move slowly and cannot move underwater. Spherical amphibious robots have high mobility on land and in water, but they have poor obstacle crossing ability and complex controls, and such movement mechanisms have not moved beyond prototypes. There are also some amphibious robots that use bionic structural design. These robots have high drive efficiency, but complex controls and poor reliability.

Based on the above problems, it is necessary to improve the existing amphibious robots.

### SUMMARY

In order to solve the above technical problems, the present invention provides an amphibious robot, which simplifies the drive system and its control system.

The present invention provides an amphibious robot, comprising: a fuselage and a propulsion mechanism, a steering mechanism and a pitch mechanism respectively connected thereto, wherein the fuselage comprises an inner shell, a propeller and a rolling outer shell which are sequentially sleeved from the inside to the outside, and the inner shell is cylindrical; the propulsion mechanism comprises a bracket, a driving motor and a first counterweight, the stator of the driving motor is fixed to the side end of the bracket, the first counterweight is fixed to the bottom of the bracket, the inner shell is sleeved outside the bracket, the side end of the inner shell is connected to the rotor of the driving motor, one side end of the inner shell is connected to the rotor of the driving motor, and the other side end is rotatably connected to the bracket; the rotation of the stator drives the first counterweight to rotate, providing a torque to the fuselage, and the rotation of the rotor drives the inner shell, the propeller and the rolling outer shell to rotate synchronously, and the robot is driven to move on the water surface/water by the reaction force.

Optionally, the rolling outer shell includes two sections of detachably connected cylindrical monomers, the outer walls of the two connected cylindrical monomers are arc-shaped along their axis, converging from the middle to both sides, and the inner shell includes two sections of detachably connected cylindrical monomers.

Optionally, the propeller includes a plurality of blades, the plurality of blades are arranged at intervals along the axial direction of the inner shell, each blade extends along the radial direction of the inner shell, and the plurality of blades form an axial spiral.

Optionally, the length of the first counterweight along the axial direction of the rolling outer shell is not less than 83% of the length of the rolling outer shell, and the first counterweight is fixed to the outer wall of the bracket.

Optionally, the steering mechanism includes: a steering motor and a second counterweight, the steering motor is fixed to the top middle position of the bracket, the output shaft of the steering motor is fixedly connected to the second counterweight, and there is a gap between the second counterweight and the bracket.

Optionally, the pitch mechanism includes a stepper motor, a horizontal moving component and a third counterweight. The stepper motor is fixed to one end of the top of the bracket, the input end of the horizontal moving component is connected to the stepper motor, the output end of the horizontal moving component is connected to the third counterweight, and the moving direction of the third counterweight is parallel to the axial direction of the inner shell.

Optionally, the horizontal moving component includes a base and a lead screw. The base is fixed to the outer side of the top of the bracket, the lead screw is rotatably connected to the base, one end of the lead screw is connected to the stepper motor, and the third counterweight is screwed to the lead screw.

Optionally, the head and tail ends of the inner shell are respectively fixed with a bullet-shaped end shell, and the end shell extends out of the end of the rolling outer shell.

Optionally, one side end of the inner shell is fixed to the rotor of the drive motor through a connecting piece, and the other side end of the inner shell is rotatably connected to the bracket through a connecting piece. The connecting piece is a cross-shaped metal piece, and the two side ends of the inner shell are provided with a cross-shaped groove, and the cross-shaped metal piece is inserted into the groove.

The technical solution provided by the embodiment of the present invention has the following advantages over the prior art:

The amphibious robot provided by the embodiment of the present invention simplifies the drive system and its control system, and shares a drive system in water and on land, that is, by designing the fuselage structure as an inner shell, a propeller and a rolling outer shell that are sequentially connected from the inside to the outside, and by fixing the first counterweight block at the bottom of the bracket, when the drive motor is started, its stator drives the bracket and all parts fixed on the bracket to rotate a certain angle, wherein the rotation of the first counterweight block provides a power torque for the robot movement, and the rotor drives the fuselage and thus drives the robot as a whole to overcome the resistance torque of the fluid/land and rotate, and the propeller can rotate when rotating. The water around it is pushed backwards, and the reaction force pushes the robot to move on the water surface/in the water. The rotation of the rolling shell can make the robot roll forward on land. The amphibious robot has a simple structural design and only requires a set of drive system and control system, which can ensure the high reliability of the robot in harsh environments. At the same time, the simple system design will allow the robot to retain more internal space for the deployment of different functional modules such as surveying and communication. The amphibious robot can move at high speed in both amphibious and terrestrial environments, and can perform various tasks faster and more efficiently. It can move and switch motion modes in multiple working environments such as land, water surface, and underwater. It can adapt to various complex terrains and fluid environments and has a wide range of application scenarios.

### BRIEF DESCRIPTION OF THE DRAWINGS

FIG. 1 is a schematic diagram of the overall structure of an amphibious robot provided by an embodiment of the present invention;

FIG. 2 is a cross-sectional view along the A-A direction in FIG. 1;

FIG. 3 is a schematic diagram of the internal overall structure of an amphibious robot provided by an embodiment of the present invention;

FIG. 4 is a side view of an amphibious robot provided by an embodiment of the present invention without the end shell;

FIG. 5 is a cross-sectional view along the B-B direction in FIG. 1.

### DESCRIPTION OF THE ACCOMPANYING DRAWINGS

1. Inner shell; 2. End shell; 3. Propeller; 4. Rolling shell; 5. Groove; 6. Bracket; 7. First counterweight; 8. Second counterweight; 9. Battery; 10. Steering motor; 11. Drive motor; 12. Stepper motor; 13. Screw; 14. Third counterweight; 15. Coupling; 16. Bearing; 17. Connector; 18. Motor control board.

### DETAILED DESCRIPTION OF EMBODIMENTS

A specific embodiment of the present invention is described in detail below in conjunction with the accompanying drawings, but it should be understood that the scope of protection of the present invention is not limited by the specific embodiment.

In the description of the present invention, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “axial”, “radial”, “circumferential” and the like indicate the orientation or position relationship based on the orientation or position relationship shown in the accompanying drawings, which is only for the convenience of describing the technical solution of the present invention and simplifying the description, rather than indicating or implying that the device or element referred to must have a specific orientation, be constructed and operated in a specific orientation, and therefore cannot be understood as a limitation of the present invention.

The present invention is described below through several specific embodiments. In order to keep the following description of the embodiments of the present invention clear and concise, the detailed description of known functions and known components may be omitted. When any component of the embodiments of the present invention appears in more than one drawing, the component may be represented by the same reference numeral in each drawing.

In view of the problems of the existing amphibious robots' complex cross-media motion driving mechanism, difficulty in miniaturization, and weak adaptability to multi-obstacle terrain environments, this invention proposes an amphibious robot that simplifies the drive system and its control system, enabling it to move efficiently in a variety of environments such as land, water and underwater, and has the ability to adapt to complex amphibious scenes.

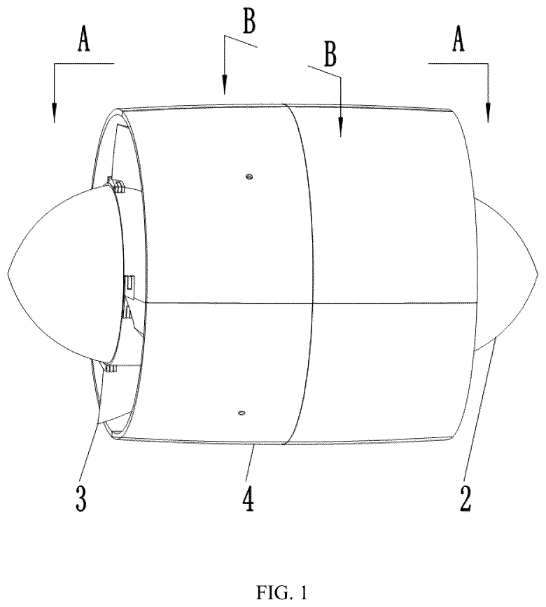

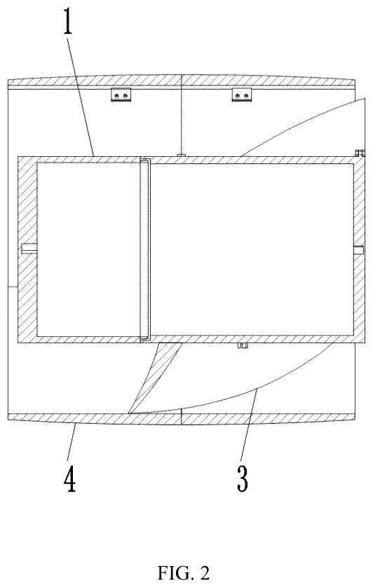

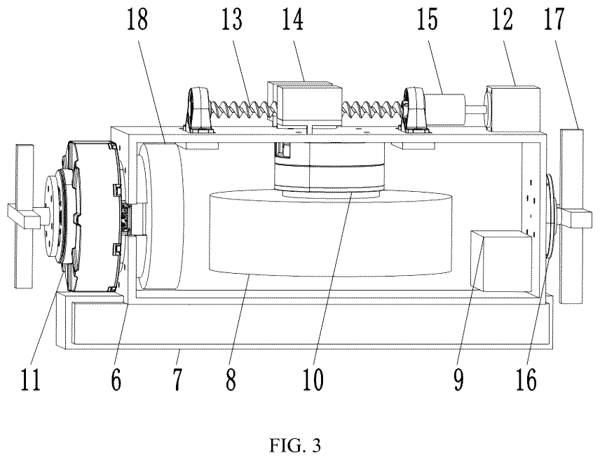

Referring to FIGS. 1, 2 and 3, FIG. 1 is a schematic diagram of the overall structure of an amphibious robot provided by an embodiment of the present invention, FIG. 2 is a cross-sectional view taken along the A-A direction in FIG. 1, and FIG. 3 is a schematic diagram of the internal overall structure of an amphibious robot provided by an embodiment of the present invention. As shown in FIGS. 1, 2 and 3, an embodiment of the present invention provides an amphibious robot, comprising: a fuselage and a propulsion mechanism, a steering mechanism and a pitch mechanism respectively connected thereto, wherein the fuselage comprises an inner shell 1, a propeller 3 and a rolling outer shell 4 which are sequentially sleeved from the inside to the outside, the inner shell 1 is cylindrical, the propeller 3 is fixedly connected to the outer periphery of the inner shell 1, the propeller 3 can adopt variable pitch blades, and the angle of attack can be adjusted by the micro-servo in the inner shell 1 to achieve dual-purpose in water and air, the rolling outer shell 4 is coaxially sleeved on the outer periphery of the inner shell 1 and fixed to the outer edge of the propeller 3, the propulsion mechanism comprises a bracket 6, a drive motor 11 and a first counterweight 7, the drive motor 11 adopts an IP68 waterproof servo motor, and the stator winding Epoxy resin is poured, and mechanical seals are installed on the rotor shaft. The stator of the drive motor 11 is fixed to the side end of the bracket 6, the first counterweight 7 is fixed to the bottom of the bracket 6, and the inner shell 1 is sleeved on the outside of the bracket 6. One side end of the inner shell 1 is connected to the rotor of the drive motor 11, and the other side end is rotatably connected to the bracket 6. The rotation of the stator drives the first counterweight 7 to rotate, providing a torque to the fuselage. The rotation of the rotor drives the inner shell 1, the propeller 3 and the rolling outer shell 4 to rotate synchronously, and the robot is driven to move on the water surface/water by the reaction force. The surface of the rolling outer shell 4 can be provided with anti-slip patterns or deformable scale structures to increase friction in land mode and automatically fit in underwater mode to reduce turbulence. The first counterweight 7 can be provided with an internal hollow filled with phase change material, which absorbs heat and melts at high temperature to lower the center of gravity and improve the ability to resist wind and waves. The gyroscopic effect generated by the stator-counterweight system stabilizes the fuselage, and the rotor-propeller system provides propulsion. The two realize power decoupling through reverse rotation, and energy consumption is reduced by 40%.

An amphibious robot provided by an embodiment of the present invention simplifies the drive system and its control system, and shares a set of drive systems in water and on land, that is, by designing the fuselage structure to be an inner shell, a propeller, and a rolling outer shell that are sequentially sleeved from the inside to the outside, and by fixing a first counterweight block at the bottom of the bracket, when the drive motor is started, its stator drives the bracket and all components fixed on the bracket to rotate a certain angle, wherein the rotation of the first counterweight block provides a power torque for the movement of the robot, and the rotor drives the fuselage and thus drives the robot as a whole to rotate to overcome the resistance torque of the fluid/land, and the propeller can push the water around it backwards when rotating, relying on the reaction force to push the robot to move on the water surface/water, and relying on the rotation of the rolling shell can to make the robot roll forward on land. The amphibious robot has a simple structural design and only requires a single drive system and control system, which can ensure the high reliability of the robot in harsh environments. At the same time, the simple system design will allow the robot to retain more internal space for the deployment of different functional modules such as surveying and communication. The amphibious robot can move at high speed in both land and water environments, and can perform various tasks faster and more efficiently. It can move and switch motion modes in multiple working environments such as land, water, and underwater, and can adapt to various complex terrains and fluid environments. Accordingly, it has a wide range of application scenarios.

Referring again to FIG. 2, the rolling shell 4 includes two sections of detachably connected cylindrical monomers, which are made of high-strength lightweight materials (such as carbon fiber or titanium alloy) and are connected by threads for quick disassembly and maintenance. The outer walls of the two connected cylindrical monomers are in an arc shape that converges from the middle to the two sides along their axis. The outer walls of the two sections of the cylindrical monomers are in a streamlined arc shape that is wide in the middle and narrow at both ends, which conforms to the fluid mechanics design, reduces the resistance to movement in water, and enhances the stability when rolling on land. The rolling shell 4 can be embedded with a shape memory alloy (SMA) skeleton, which can fine-tune the curvature under the stimulation of a specific temperature or electrical signal to optimize the movement efficiency in different media (water/land/mud). The middle part of the rolling shell 4 can be integrated with a telescopic The auxiliary wheel automatically unfolds in complex terrain (such as sand and gravel) to prevent sinking into soft ground. The inner shell 1 includes two detachably connected cylindrical monomers, which are detachably connected by threads to facilitate the installation of the internal structure. The inner shell 1 can be made of carbon fiber-Kevlar composite material, which takes into account both lightness and impact resistance. The porous energy-absorbing foam is filled inside to buffer the shock waves of underwater explosions or collisions. The inner shell 1 and the bracket 6 can be connected by a magnetic bearing to reduce mechanical friction and reduce the energy consumption of the drive motor 11. The outer wall of the rolling shell 4 is in an arc shape along its axis that converges from the middle to both sides, which can reduce the resistance of movement in water, and the rolling shell 4 of this shape is easier to turn when moving on land.

Specifically, the propeller 3 includes a plurality of blades, which are arranged at intervals along the axial direction of the inner shell 1, with each blade extending radially along the inner shell 1, and the plurality of blades forming an axial spiral shape. For example, four blades can be arranged, evenly distributed along the axial direction of the inner shell 1, and each blade can present a radially extending airfoil cross-section, taking into account both thrust and efficiency. The blades can adopt a variable pitch design, with a larger pitch at the root close to the inner shell 1 to provide strong thrust, and a smaller pitch at the tip to reduce cavitation effects and underwater noise. The blade surface can be covered with a shark skin-like micro-groove coating to reduce turbulent resistance and improve underwater propulsion efficiency by 10% to 15%. The plurality of blades form an axial spiral shape and have a large propulsion force when moving in the fluid.

Referring again to FIG. 3, the length of the first counterweight block 7 along the axial direction of the rolling shell 4 is not less than 83% of the length of the rolling shell 4, and the first counterweight block 7 is fixed to the outer wall of the bracket 6. The length of the first counterweight 7 extends nearly the full length of the robot. The longer the counterweight, if space allows, the greater the torque it can provide. In theory, the farther the center of mass of the first counterweight 7 is from the axis of the robot, the better, as the driving torque will be increased with distance.

Optionally, a steering mechanism includes: a steering motor 10 and a second counterweight 8. The steering motor 10 is fixed to the top middle position of the bracket 6, which can keep the center of gravity of the robot in the middle at an initial phase. The output shaft of the steering motor 10 is fixedly connected to the second counterweight 8. There is a gap between the second counterweight 8 and the bracket 6. The larger the diameter and the higher the height of the cylindrical second counterweight 8, the better. The actual design is limited by space.

Steering movement: When the steering motor 10 is working, its rotor drives the second counterweight 8 to rotate and generate angular acceleration. At the same time, according to the conservation of angular momentum, the entire robot also generates angular acceleration, which is opposite to the rotation direction of the second counterweight 8, thereby driving the robot to turn in fluid and land environments.

Optionally, a pitch mechanism includes a stepper motor 12, a horizontal moving component and a third counterweight 14. The stepper motor 12 is fixed to one end of the top of the bracket 6, which can keep the center of gravity of the robot in the middle at the beginning. The input end of the horizontal moving component is connected to the stepper motor 12, and the output end of the horizontal moving component is connected to the third counterweight 14. The moving direction of the third counterweight 14 is parallel to the axial direction of the inner shell 1.

Pitch motion in fluid: When the stepper motor 12 above the bracket 6 is working, it drives the third counterweight 14 connected to the horizontal moving component to move linearly along the axial direction of the robot, thereby changing the center of mass position of the robot. When the movement direction of the third counterweight 14 is consistent with the movement direction of the robot, the robot head tilts downward, and the robot moves downward in the water. When the movement direction of the third counterweight 14 is opposite to the movement direction of the robot, the robot head tilts upward, and the robot moves upward in the water. After the robot floats to the surface, the robot can move stably on the water surface. In addition, when the robot moves on land, the third counterweight 14 can be driven to move to the tail by the stepper motor 12, and the robot center of mass position can be changed to achieve a larger turning radius.

In this embodiment, the horizontal moving component includes a base and a lead screw 13. The base is fixed to the outer side of the top of the bracket 6, and the lead screw 13 is rotatably connected to the base. One end of the lead screw 13 is connected to the stepper motor 12 through a coupling 15. The third counterweight 14 is screwed to the lead screw 13. The use of a lead screw nut has the following advantages: 1) high precision, which is conducive to fine-tuning the center of gravity of the robot; 2) high rigidity and transmission efficiency; 3) good performance at high speed, which is conducive to quickly adjusting the center of gravity of the robot; 4) limited space requirement, which is conducive to miniaturization of the robot.

Optionally, the inner shell 1 is fixedly connected to the head and tail ends with a bullet-shaped end shell 2, which can reduce the resistance of the robot moving in the fluid, and the end shell 2 extends out of the end of the rolling outer shell 4.

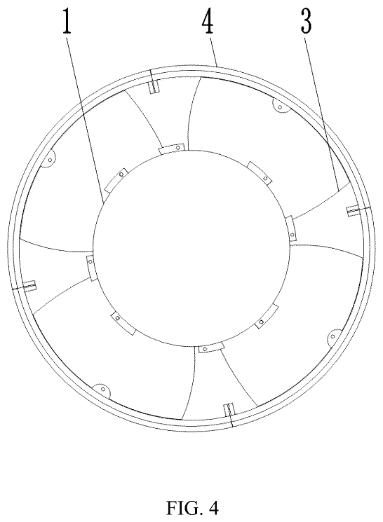

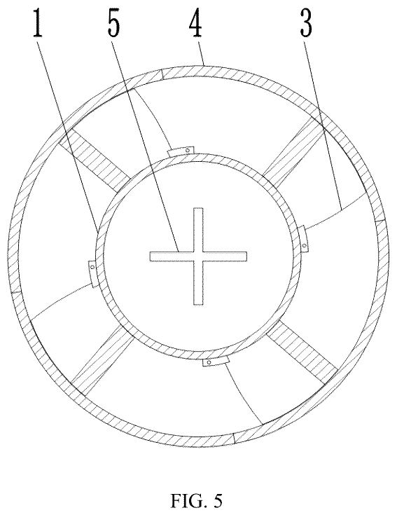

Referring to FIGS. 4 and 5, FIG. 4 is a cross-sectional view of the B-B direction in FIG. 1, and FIG. 5 is a schematic diagram of the internal overall structure of an amphibious robot provided by an embodiment of the present invention. As shown in FIGS. 4 and 5, one side end of the inner shell 1 is fixedly connected to the rotor of the drive motor 11 through a connecting member 17, and the other side end of the inner shell 1 is rotatably connected to the bracket 6 through a connecting member 17. The connecting member 17 is a cross-shaped metal member. The two side ends of the inner shell 1 are provided with a cross-shaped groove 5, and the cross-shaped metal member is inserted into the groove 5. The battery 9 is fixed on the inner side of the bracket 6 near the stepper motor 12, and the motor control board 18 is arranged on the opposite side of the bracket 6.

The present invention provides an amphibious robot with four symmetrically distributed propeller blades and a rolling outer shell 4 composed of eight arc-shaped parts designed for the inner shell 1. The reaction force between the propeller 3 and the water when rotating is used to drive the robot to move efficiently in the fluid. At the same time, the rolling outer shell 4 is used to realize the land movement of the robot, simplifying the motive mechanism so that it can work in a complex amphibious environment, realizing driving and steering by using the conservation of angular momentum, and realizing the surface/underwater operation of the robot by changing the center of mass position, with correspondingly simple controls. The robot integrates amphibious movement, a simple motion mechanism, small size and light weight (see Table 1 for comparison). The robot is capable of flexibly switching between surface and underwater movement, and solves the problems of complex structure, cumbersome control, inconvenient deployment and recovery, complex driving principles, poor maneuverability, weak environmental adaptability, and poor reliability of existing amphibious robots. Specifically:
1) From the perspective of integrated drive principle, the amphibious robot provided by the present invention has a simple structural design and only requires only a single drive and control system, which can ensure the high reliability of the robot in harsh environments. At the same time, the simple system design will allow the robot to retain more internal space for the deployment of different functional modules such as surveying and communication;
2) From the perspective of mobility, the amphibious robot provided by the present invention can travel at high speed in both amphibious and terrestrial environments, and can perform various tasks faster and more efficiently;
3) From the perspective of environmental adaptability, the amphibious robot can move and switch motion modes in multiple working environments such as land, water, and underwater, and can adapt to various complex terrains and fluid environments, with a wide range of applications.

TABLE 1
Amphibious robots developed by domestic
and foreign institutions and their sizes

| Institution | Robot Size | |
|---|---|---|
| Ecole Polytechnique Fédérale de | Length 77 cm (snake-like robot) | |
| Lausanne (2006) | | |
| McGill University (2013) | 64 × 44 × 13 | cm |
| GuardBot (2014) | Diameter 14 cm-2.5 m (spherical | |
| | robot) | |
| Bayonet Ocean Vehicles (2023) | 122 × 132 × 35.5 | cm |
| Harbin Engineering University | 60 × 50 × 22 | cm |
| (2022) | | |

| | |
|---|---|
| Xi'an Jiaotong University (2025, | Diameter 18-40 cm, length 57.6 cm |
| this invention) | |

The amphibious robot provided by the present invention integrates the advantages of miniaturization, simple motion mechanism, easy control, efficient and flexible motion, strong environmental adaptability, and reliable work, solving the common problems of amphibious robots at present, such as structural complexity, cumbersome control, inconvenient deployment and recovery, complexity of operation, poor maneuverability, poor environmental adaptability, and poor reliability. This enables the robot to replace humans in complex application scenarios such as hydrological surveys, emergency rescue, aquaculture, and pipeline inspections, with corresponding reduction in the risk of human casualties, increased efficiency, and increased reliability.

The above inventions are only a few specific embodiments of the present invention, but the embodiments of the present invention are not limited thereto, and any changes that can be thought of by technicians in this field should fall within the scope of protection of the present invention.

What is claimed is:

1. An amphibious robot comprising: a fuselage and a propulsion mechanism, a steering mechanism and a pitch mechanism each connected to the fuselage, wherein:
the fuselage comprises an inner shell (1), a propeller (3) and a rolling outer shell (4) which are sequentially sleeved from the inside to the outside, and the inner shell (1) is cylindrical;
the propulsion mechanism comprises a bracket (6), a drive motor (11) and a first counterweight (7), wherein the stator of the drive motor (11) is fixed to a first side end of the bracket (6), the first counterweight (7) is fixed to an outer wall of the bracket (6), the inner shell (1) is sleeved outside the bracket (6), a first side end of the inner shell (1) is connected to the rotor of the drive motor (11), and a second side end of the inner shell is rotatably connected to the bracket (6);
wherein the rotation of the stator relative to the rotor drives the first counterweight (7) to rotate, thereby providing a torque to the fuselage, and wherein the rotation of the rotor drives the inner shell (1), the propeller (3) and the rolling outer shell (4) to rotate synchronously, thereby driving the robot to move on or through water by means of a reaction force.

2. An amphibious robot as claimed in claim 1, characterized in that the rolling outer shell (4) comprises two detachable cylindrical sections, wherein each cylindrical section has an outer wall with a curved profile that tapers axially from a middle portion toward opposite ends, and wherein the inner shell (1) comprises two sections of detachable cylindrical sections.

3. An amphibious robot as claimed in claim 1, characterized in that the propeller (3) comprises a plurality of blades, wherein the plurality of blades are arranged in intervals along the axial direction of the inner shell (1), wherein each blade extends radially from the inner shell (1), and wherein the plurality of blades form an axial spiral shape.

4. An amphibious robot as claimed in claim 1, characterized in that the length of the first counterweight block (7) along the axial direction of the rolling shell (4) is not less than 83% of the length of the rolling shell (4), and wherein the first counterweight block (7) is fixed to the outer wall of the bracket (6).

5. An amphibious robot as claimed in claim 1, characterized in that the steering mechanism comprises: a steering motor (10) and a second counterweight (8), wherein the steering motor (10) is fixed at a central top position of the bracket (6), the output shaft of the steering motor (10) is fixedly connected to the second counterweight (8), and there is a gap between the second counterweight (8) and the bracket (6).

6. An amphibious robot as claimed in claim 1, characterized in that the pitch mechanism comprises a stepper motor (12), a horizontal moving assembly and a third counterweight (14), wherein the stepper motor (12) is fixed a top end of the bracket (6), the input end of the horizontal moving assembly is connected to the stepper motor (12), the output end of the horizontal moving assembly is connected to the third counterweight (14), and third counterweight (14) moves along a direction parallel to the axial direction of the inner shell (1).

7. An amphibious robot as claimed in claim 6, characterized in that the horizontal moving assembly includes a base and a lead screw (13), wherein the base is fixed to an exterior of the top of the bracket (6), the lead screw (13) is rotatably connected to the base, one end of the lead screw (13) is connected to the stepper motor (12), and the third counterweight (14) is threadedly connected to the lead screw (13).

8. An amphibious robot as claimed in claim 1, wherein opposite ends of the inner shell (1) are respectively fixedly connected with a bullet-shaped end shell (2), and the end shell (2) extends beyond the end of the rolling outer shell (4).

9. An amphibious robot as claimed in claim 1, characterized the first side end of the inner shell (1) is fixedly connected to the rotor of the drive motor (11) through a connecting member (17), and the second side end of the inner shell (1) is rotatably connected to the bracket (6) through the connecting member (17), and the connecting member (17) is a cross-shaped metal piece, and first and second ends of the inner shell (1) are comprise cross-shaped grooves (5), configured to receive the cross shaped metal plate.
